(19) United States
(12) Patent Application Publication
(10) Pub. No.: US 2021/0362663 A1
(43) Pub. Date: Nov. 25, 2021

(54) BEAM MEMBER

(71) Applicants: Sumitomo Electric Industries, Ltd., Osaka-shi, Osaka (JP); Sumitomo Wiring Systems, Ltd., Yokkaichi, Mie (JP)

(72) Inventors: Eisuke HIRO, Osaka-shi, Osaka (JP); Masatada NUMANO, Osaka-shi, Osaka (JP); Tetsuya NISHIMURA, Yokkaichi, Mie (JP); Shigeki IKEDA, Yokkaichi, Mie (JP); Motohiro YOKOI, Yokkaichi, Mie (JP); Daisuke EBATA, Yokkaichi, Mie (JP); Ryuta TAKAKURA, Yokkaichi, Mie (JP)

(73) Assignees: Sumitomo Electric Industries, Ltd., Osaka-shi, Osaka (JP); Sumitomo Wiring Systems, Ltd., Yokkaichi, Mie (JP)

(21) Appl. No.: 16/765,676

(22) PCT Filed: Nov. 1, 2018
(86) PCT No.: PCT/JP2018/040763

§ 371 Date: May 20, 2020

(30) Foreign Application Priority Data
Nov. 22, 2017 (JP) 2017-224517

(51) Int. Cl. B60R 16/02; H02G 3/04

(52) U.S. Cl. CPC B60R 16/0215; H02G 3/045

(57) ABSTRACT

A beam member includes: a wire harness; and a hollow metal tube provided to cover at least a portion of the wire harness, wherein the hollow metal tube is provided with a main body portion that covers at least the portion of the wire harness, at least one first protrusion, at least one second protrusion, and at least one flange portion at which a pair of the first protrusion and the second protrusion are fixed, the at least one flange portion protruding toward an outside of the main body portion along a long side direction of the hollow metal tube, and an opening serving as a pullout opening for the wire harness and located at a certain portion of the main body portion in the long side direction, and ε≥17 N/mm² is satisfied.

### TECHNICAL FIELD

The present disclosure relates to a beam member. The present application claims a priority based on Japanese Patent Application No. 2017-224517 filed on Nov. 22, 2017, the entire content of which is incorporated herein by reference.

### BACKGROUND ART

As a beam member, an operator compartment supporting structure of a vehicle in Patent Literature 1 has been known. This supporting structure includes a cross member (one type of beam member) having two tube-like members having different shapes and formed through extrusion molding. The two tube-like members having different shapes are welded to each other.

### CITATION LIST

### Patent Literature

PTL 1: Japanese Patent Laying-Open No. 2013-28337

### SUMMARY OF INVENTION

A beam member according to the present disclosure includes:

a wire harness; and

a hollow metal tube provided to cover at least a portion of the wire harness, wherein

the hollow metal tube is provided with
a main body portion that covers at least the portion of the wire harness,
at least one first protrusion,
at least one second protrusion,
at least one flange portion at which a pair of the first protrusion and the second protrusion are fixed, the at least one flange portion protruding toward an outside of the main body portion along a long side direction of the hollow metal tube, and
an opening serving as a pullout opening for the wire harness and located at a certain portion of the main body portion in the long side direction, and

ε≥17 N/mm² is satisfied when α represents a 0.2% proof stress of a material of the hollow metal tube, β represents a cross sectional area of the hollow metal tube except for an internal space of the hollow metal tube, γ represents an axial allowable load of the hollow metal tube and is calculated by α×β, δ represents a total cross sectional area of the hollow metal tube and the internal space, and E represents an allowable load of the hollow metal tube for an occupied cross sectional area of the hollow metal tube and is calculated by γ/δ.

### BRIEF DESCRIPTION OF DRAWINGS

FIG. 1 is a perspective view showing an overview of a beam member according to a first embodiment.

FIG. 2 is a cross sectional view showing a state in which the beam member shown in FIG. 1 is taken along a (II)-(II) cross sectional line.

FIG. 3 is a cross sectional view showing a state in which the beam member shown in FIG. 1 is taken along a (III)-(III) cross sectional line.

FIG. 4 is a perspective view showing an overview of another exemplary beam member according to the first embodiment.

FIG. 5 is a perspective view showing an overview of a beam member according to a second embodiment.

FIG. 6 is a cross sectional view showing a state in which the beam member shown in FIG. 5 is taken along a (VI)-(VI) cross sectional line.

FIG. 7 is a cross sectional view showing a state in which the beam member shown in FIG. 5 is taken along a (VII)-(VII) cross sectional line.

FIG. 8 is a cross sectional view showing a state in which the beam member shown in FIG. 5 is taken along a (VIII)-(VIII) cross sectional line.

FIG. 9 is a cross sectional view showing a hollow metal tube of each of samples No. 1 to No. 4.

FIG. 10 is a cross sectional view showing a hollow metal tube of a sample No. 5.

FIG. 11 is a cross sectional view showing a hollow metal tube of each of samples No. 101 and No. 102.

### DETAILED DESCRIPTION

### Problem to be Solved by the Present Disclosure

A transportation device such as a vehicle employs a wire harness in which a plurality of electric wires are bundled as a wiring for electric devices. Generally, such a wire harness is attached to an outer peripheral surface of a cross member along an axial direction of the cross member using a band, a tape, or the like at an internal side (engine compartment side) relative to an instrument panel of the vehicle. In recent years, as vehicles have higher performance and more advanced functions, the number of electric devices mounted thereon are increased, with the result that the number of electric wires (wire harnesses) also tends to be increased.

A wire harness having an increased number of electric wires is less likely to be bent. This makes it difficult to route such a wire harness. This is because various members are disposed around the cross member and a space is therefore limited. Moreover, when the number of electric wires is increased, the electric wires are more likely to come into contact with a member therearound. This requires a protective member (such as a cover) for preventing an electric wire from being damaged by such contact, thus presumably resulting in further decrease of the limited space.

In view of the above, it is one object to provide a beam member allowing for space saving.

### Advantageous Effect of the Present Disclosure

The beam member allows for space saving.

### DESCRIPTION OF EMBODIMENTS

First, contents of embodiments of the present disclosure are listed and described.

(1) A beam member according to one embodiment of the present disclosure includes:

a wire harness; and

a hollow metal tube provided to cover at least a portion of the wire harness, wherein

the hollow metal tube is provided with
a main body portion that covers at least the portion of the wire harness,
at least one first protrusion,
at least one second protrusion,
at least one flange portion at which a pair of the first protrusion and the second protrusion are fixed, the at least one flange portion protruding toward an outside of the main body portion along a long side direction of the hollow metal tube, and
an opening serving as a pullout opening for the wire harness and located at a certain portion of the main body portion in the long side direction, and

ε≥17 N/mm² is satisfied when α represents a 0.2% proof stress of a material of the hollow metal tube, β represents a cross sectional area of the hollow metal tube except for an internal space of the hollow metal tube, γ represents an axial allowable load of the hollow metal tube and is calculated by α×β, δ represents a total cross sectional area of the hollow metal tube and the internal space, and c represents an allowable load of the hollow metal tube for an occupied cross sectional area of the hollow metal tube and is calculated by γ/δ.

According to the above-described configuration, space saving can be attained. This is due to the following reason: since the hollow metal tube that stores the wire harness therein is included, the wire harness does not need to be attached to an outer peripheral surface of the hollow metal tube using a band, a tape, or the like. Moreover, since the wire harness and the hollow metal tube can be readily handled as one piece, the number of components can be reduced.

Moreover, damage to the wire harness is likely to be suppressed. This is due to the following reason: since the wire harness is stored in the hollow metal tube, the wire harness can be mechanically protected from an external environment.

Furthermore, since the pullout opening is provided at the certain portion of the hollow metal tube, a degree of freedom in routing the wire harness is high. This is because the wire harness can be pulled out from any location by appropriately adjusting the location of the pullout opening.

Moreover, even though the main body portion is provided with the pullout opening, the mechanical strength (rigidity) of the hollow metal tube can be suppressed from being decreased. This is because mechanical strength (rigidity) can be improved due to the inclusion of the flange portion and allowable load E of more than or equal to 17 N/mm².

(2) As one embodiment of the beam member, the wire harness has at least one of a connector fitted in the pullout opening and a pullout part pulled out from the pullout opening toward the outside of the main body portion.

Since movement of the wire harness in the hollow metal tube is likely to be suppressed by the connector fitted in the pullout opening, the wire harness and the hollow metal tube is readily handled as one piece. The pullout part pulled out from the pullout opening is not regulated in its movement outside the main body portion, and is handled freely to some extent. Accordingly, the pullout part can be readily directed in various directions, thus facilitating connection to a connector of an intended wire harness.

(3) As one embodiment of the beam member, the pullout opening has a lower side pullout opening that opens at a lower side of the main body portion in a vertical direction.

According to the above-described configuration, even when water drops are generated due to condensation of water vapor inside the hollow metal tube, the water drops are facilitated to flow to the lower side due to gravity to be thereby discharged from the lower side pullout opening to the outside of the main body portion. Since the lower side pullout opening can be thus used as a water discharging hole, water drops are less likely to be accumulated in the hollow metal tube, whereby the water drops are likely to be suppressed from being adhered to the wire harness.

(4) As one embodiment of the beam member,

the hollow metal tube is formed by combining a first divided piece and a second divided piece, and has one main body portion and two flange portions protruding in opposite directions,

the first divided piece has
a first peripheral wall portion that forms a portion of the main body portion, and
two first protrusions that protrude, in the opposite directions, from respective ends of the first peripheral wall portion to form respective portions of the flange portions, and

the second divided piece has
a second peripheral wall portion that forms a portion of the main body portion, and
two second protrusions that protrude, in the opposite directions, from respective ends of the second peripheral wall portion to form respective portions of the flange portions.

According to the above-described configuration, an operation for fixing each flange portion is facilitated as compared with a case where the two flange portions protrude in the same direction. This is due to the following reason: by pressing the main body portion, the flange portions can be kept in contact with each other, with the result that even in the case where the flange portions are fixed one after the other, when fixing one flange portion, the contact state of the other flange portion is less likely to be deviated or eliminated. Moreover, although depending on a fixation method, the two flange portions can be fixed simultaneously.

(5) As one embodiment of the beam member,

the hollow metal tube is formed by combining a first divided piece and a second divided piece, and has one main body portion and two flange portions protruding in the same direction,

the first divided piece has
a first peripheral wall portion that forms a portion of the main body portion, and
two first protrusions that protrude, in the same direction, from respective ends of the first peripheral wall portion to form respective portions of the flange portions, and

the second divided piece has
a second peripheral wall portion that forms a portion of the main body portion, and
two second protrusions that protrude, in the same direction, from respective ends of the second peripheral wall portion to form respective portions of the flange portions.

According to the above-described configuration, an operation for fixing the flange portions can be performed in the same direction.

(6) As one embodiment of the beam member having the two flange portions protruding in the same direction,

the pullout opening has a protrusion side pullout opening that opens between the two flange portions in the same direction as the protrusion direction of the flange portions in the main body portion, and

the wire harness has a connector fitted in the protrusion side pullout opening.

According to the above-described configuration, an exposed portion of the connector through the protrusion side pullout opening can be surrounded to some extent by the two flange portions, whereby the exposed portion is likely to be mechanically protected. Accordingly, damage to the connector is likely to be suppressed.

(7) As one embodiment of the beam member, the material of the hollow metal tube is one metal selected from pure magnesium, a magnesium alloy, pure aluminum, an aluminum alloy, pure iron, and an iron alloy.

The pure magnesium or magnesium alloy is light in weight and is excellent in flexural rigidity and impact resistance. The pure aluminum or aluminum alloy is light in weight, is excellent in mechanical strength, and is likely to provide an increased degree of freedom in shape. The pure iron or iron alloy is excellent in rigidity and mechanical strength.

(8) As one embodiment of the beam member, the flange portion has a friction-stir-welded portion at which the first and second protrusions disposed to face each other are friction-stir-welded.

According to the above-described configuration, the protrusions can be firmly joined together, thereby increasing mechanical strength of the flange portion. Accordingly, flexural rigidity is likely to be improved. Moreover, since the protrusions can be firmly joined, the protrusions facing each other are less likely to be separated from each other due to application of external force. In the case of the friction stir welding, a long range, preferably, the entire length of the flange portion in the long side direction can be firmly welded.

(9) As one embodiment of the beam member having the friction-stir-welded portion, the beam member further includes a heat insulator interposed between the wire harness and the hollow metal tube to protect the wire harness from heat resulting from the friction stir welding.

According to the above-described configuration, an electric insulator of an electric wire included in the wire harness can be suppressed from being damaged by heat resulting from the friction stir welding.

(10) As one embodiment of the beam member, the beam member further includes a fastening member that fastens the first and second protrusions disposed to face each other, in a stacking direction of the first and second protrusions, wherein

each of the first and second protrusions is provided with a through hole in which the fastening member is insertable.

According to the above-described configuration, the protrusions are mechanically fixed by the fastening member. Hence, the protrusions can be fixed readily as compared with the case of the friction stir welding. Moreover, the fixed protrusions can be readily separated. Hence, when exchanging the wire harness, the wire harness can be readily removed from within the hollow metal tube.

### DETAILS OF EMBODIMENTS OF THE PRESENT DISCLOSURE

Details of the embodiments of the present disclosure will be described below with reference to figures. The same reference characters in the figures represent the same designations.

### First Embodiment

[Beam Member]

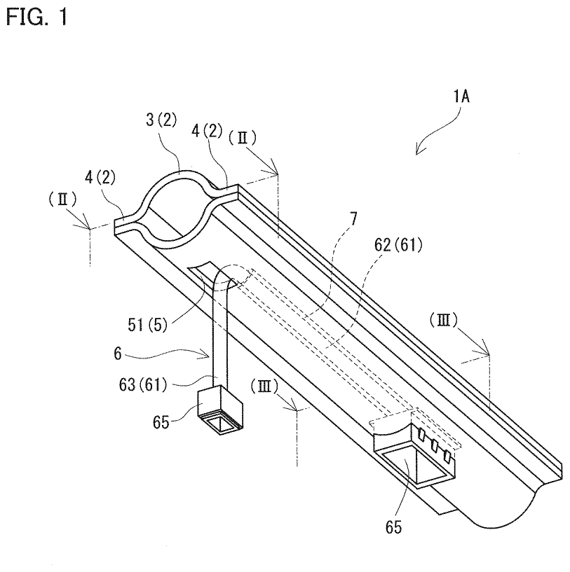

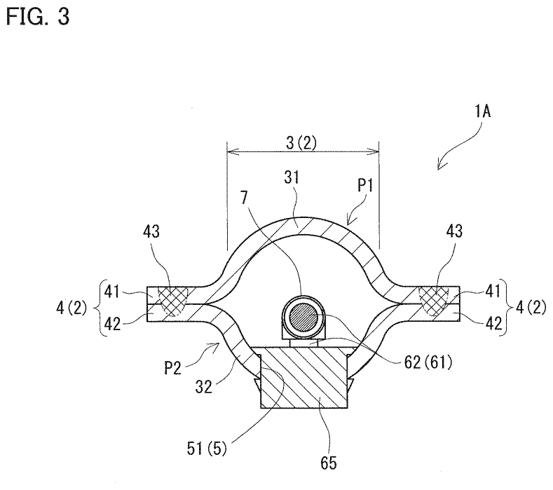

With reference to FIG. 1 to FIG. 4, a beam member 1A according to a first embodiment will be described. Beam member 1A according to the first embodiment includes: a hollow metal tube 2; and a wire harness 6 stored in hollow metal tube 2. One of features of beam member 1A lies in that hollow metal tube 2 has flange portions 4 protruding toward an outside thereof and is provided with an pullout opening 5 for a wire harness 6 and hollow metal tube 2 has a specific physical property falling within a specific range. The following describes hollow metal tube 2 and wire harness 6 in this order. FIG. 1 shows a perspective view when beam member 1A is seen from a lower side in the vertical direction. For ease of description, in each of FIG. 1 to FIG. 4, a plurality of electric wires 61 included in wire harness 6 are collectively shown as one electric wire in a simplified manner. In FIG. 3, a cross section of a connector 65 is shown in a simplified manner.

[Hollow Metal Tube]

Hollow metal tube 2 has an internal space in which wire harness 6 is stored. This internal space is a space closed, in the peripheral direction of hollow metal tube 2, at regions of hollow metal tube 2 other than below-described pullout opening 5. Namely, hollow metal tube 2 has a hollow closed cross sectional portion that closes the inside of hollow metal tube 2 in the peripheral direction. Each of respective ends of hollow metal tube 2 in the axial direction may be opened as in the present example, or may be closed. The shape of hollow metal tube 2 can be appropriately selected depending on its application, and hollow metal tube 2 is an elongated tubular body (FIG. 1) in the present example. Examples of the elongated tubular body include: a body straightly extending along the long side direction as in the present example; a body extending in the form of an arc or in a meandering manner; a body extending in the form of Z to have a bent portion locally bent in the long side direction; and the like. This hollow metal tube 2 is provided with a main body portion 3, flange portions 4, and pullout opening 5.

(Main Body Portion)

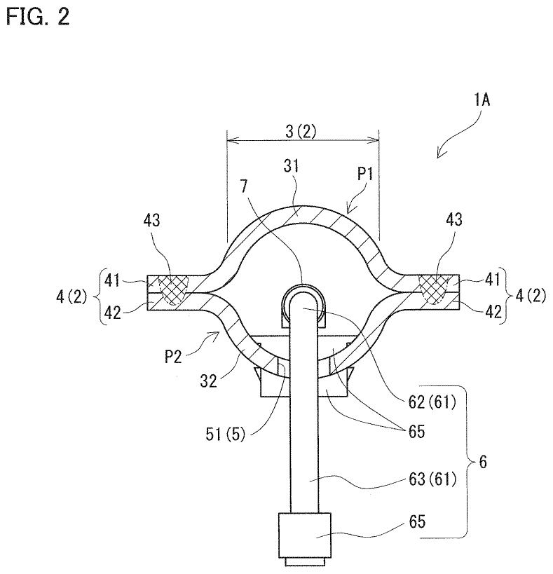

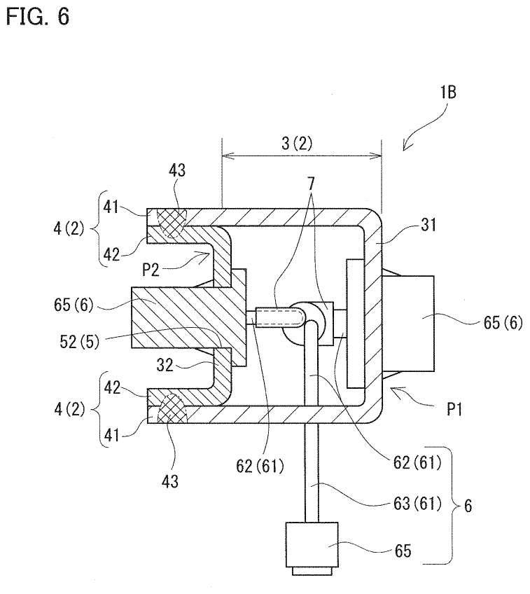

Main body portion 3 substantially forms the above-described internal space at the regions of hollow metal tube 2 other than flange portions 4. Examples of the cross sectional shape of this main body portion 3 (the cross sectional shape of the internal space) include: a circular loop shape (circular shape) as shown in FIG. 2 and FIG. 3 in the present example; a polygonal loop shape (polygonal shape) such as a rectangular loop shape (rectangular shape) as shown in FIG. 6 to FIG. 8 in a below-described second embodiment; a semicircular loop shape (semicircular shape) not shown in the figures; an elliptical loop shape (elliptical shape); and the like. The cross sectional shape of main body portion 3 may have a uniform shape along the axial direction of hollow metal tube 2 as in the present example, or may have a plurality of different shapes. For example, main body portion 3 may have: a portion having a circular loop cross sectional shape; and a portion having a rectangular loop cross sectional shape. The cross sectional shape of main body portion 3 (the cross sectional shape of the internal space) may be uniform in size in the axial direction, or may have portions with different sizes. For example, main body portion 3 may have at least one of: a size-increased portion of the internal space with a locally large cross sectional area; and a size decreased portion of the internal space with a locally small cross sectional area (both not shown in the figures).

(Flange Portion)

Each of flange portions 4 is a portion of hollow metal tube 2 protruding toward the outside of main body portion 3, and provides an increased flexural rigidity of hollow metal tube 2 (FIG. 2, FIG. 3). Flange portion 4 has a pair of protrusions (a first protrusion 41 and a second protrusion 42) disposed to face each other and fixed to each other. The size (length, width, and thickness) of flange portion 4 can be selected appropriately.

As the length of flange portion 4 in the axial direction of hollow metal tube 2 is longer, the flexural rigidity of hollow metal tube 2 is more likely to be increased. In the present example, a formation region (length) of flange portion 4 in the axial direction of hollow metal tube 2 corresponds to a region (length) across the entire length of hollow metal tube 2 in the axial direction (FIG. 1). The length of flange portion 4 may correspond to a region (length) of at least a portion of hollow metal tube 2 in the axial direction. When the formation region of flange portion 4 corresponds to the region of the portion of hollow metal tube 2 in the axial direction, flange portion 4 may be provided to be divided into a plurality of portions in the axial direction of hollow metal tube 2, for example. In that case, a region having only main body portion 3 with no flange portion 4 being formed exists between flange portions 4. Flange portion 4 has a uniform width in the long side direction of flange portion 4 in the present example, but may have different widths. Examples of the case where flange portion 4 has different widths include a case where flange portion 4 has at least one of a narrow-width portion (notch portion) having a locally narrow width and a wide-width portion having a locally wide width. Flange portion 4 has a uniform thickness in the long side direction in the present example, but may have different thicknesses.

The number of flange portions 4 is two (plural) in the present example, but may be more than or equal to three, or may be one (main body portion 3 has a C-like shape). Two flange portions 4 may be formed at sides opposite to each other in the peripheral direction of hollow metal tube 2 as in the present example (FIG. 2, FIG. 3), or may be formed at the same side as in the below-described second embodiment (FIG. 6 to FIG. 8). When two flange portions 4 protrude in the opposite directions, an operation for fixing each of flange portions 4 can be facilitated as compared with a case where the two flange portions protrude in the same direction. This is due to the following reason: by pressing main body portion 3, flange portions 4 can be kept in contact with each other, with the result that even in the case where flange portions 4 are fixed one after the other, when fixing one flange portion, the contact state of the other flange portion is less likely to be deviated or eliminated. Moreover, although depending on a fixation method, two flange portions 4 can also be simultaneously fixed in the case of friction stir welding or laser welding, for example. An effect exhibited in the case where two flange portions 4 protrude in the same direction will be described in the second embodiment. Both flange portions 4 in the present example are located on the same plane.

When the plurality of flange portions 4 are provided, first protrusion 41 and second protrusion 42 are constituted of members independent of each other. Namely, hollow metal tube 2 is formed by combining the same number of divided pieces (described below) as the number of flange portions 4.

Here, hollow metal tube 2 includes main body portion 3 and two flange portions 4, and is formed by combining two plate-like divided pieces (a first divided piece P1 and a second divided piece P2) having the same shape and the same size. First divided piece P1 includes: a peripheral wall portion 31 having a semicircular arc cross section; and a pair of first protrusions 41 externally protruding from respective ends of peripheral wall portion 31 in the radial direction. Second divided piece P2 includes a peripheral wall portion 32 and a pair of second protrusions 42, which are similar to those of first divided piece P1. In hollow metal tube 2, first protrusion 41 and second protrusion 42 at one side are disposed to face each other and first protrusion 41 and second protrusion 42 at the other side are disposed to face each other such that respective side surfaces of first divided piece P1 and second divided piece P2 are aligned with each other. That is, main body portion 3 of hollow metal tube 2 includes peripheral wall portions 31, 32, flange portion 4 at one side includes first protrusion 41 and second protrusion 42 at the one side, and flange portion 4 at the other side includes first protrusion 41 and second protrusion 42 at the other side.

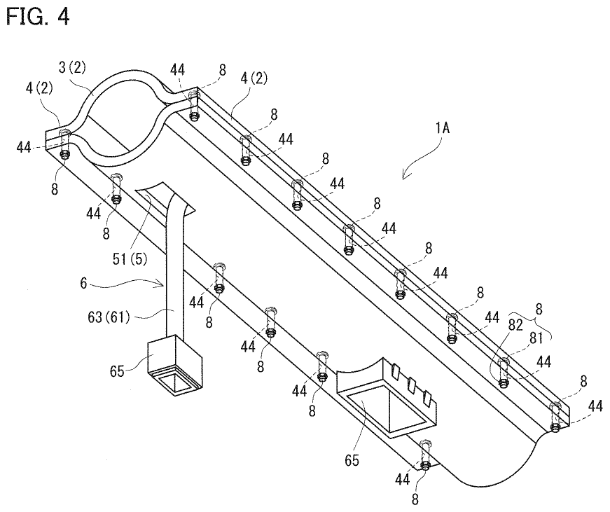

A fixation method for first protrusion 41 and second protrusion 42 can be selected appropriately. Examples of the fixation method include: friction stir welding (FIG. 2, FIG. 3); welding (for example, laser); mechanical fastening with fastening members 8 (FIG. 4); and the like. A plurality of fixation methods among these may be used.

In the present example, each of flange portions 4 has a friction-stir-welded portion 43 (FIG. 2, FIG. 3) at which respective materials of first protrusion 41 and second protrusion 42 are friction-stir-welded to each other. As the region in which friction-stir-welded portion 43 is formed is larger, joining strength between first protrusion 41 and second protrusion 42 is increased, whereby the flexural rigidity of hollow metal tube 2 is improved. In the case of the friction stir welding, a long range, preferably, the entire length of flange portion 4 in the long side direction can be firmly welded.

It should be noted that in the case where the fixation method is laser welding, flange portion 4 has a laser-welded portion formed by laser welding. The laser-welded portion is formed in the form of a line at the side surface of each of protrusions 41, 42. By forming the laser-welded portion in the form of a line, protrusions 41, 42 can be welded to each other firmly.

In the case where the fixation method is mechanical fastening with fastening members 8, protrusions 41, 42 are provided with through holes 44 in which fastening members 8 are insertable (FIG. 4). Fastening members 8 may be bolts 81 and nuts 82, or may be rivets (not shown), for example. By inserting bolts 81 into through holes 44 and fastening them with the nuts, protrusions 41, 42 can be fastened to each other in a stacking direction thereof. On the other hand, by inserting the rivets into through holes 44 and caulking them, protrusions 41, 42 can be fastened to each other in the stacking direction thereof. The plurality of fastening members 8 and through holes 44 are provided. As the respective numbers of fastening members 8 and through holes 44 are larger, protrusions 41, 42 can be more firmly fixed to each other. The plurality of fastening members 8 and through holes 44 are provided at equal intervals in the long side direction of flange portion 4. Since protrusions 41, 42 are mechanically fixed by fastening members 8, protrusions 41, 42 can be fixed readily as compared with the friction stir welding. Moreover, fixed divided pieces P1, P2 can be readily separated. Hence, when exchanging wire harness 6, wire harness 6 can be readily removed from within hollow metal tube 2.

(Pullout Opening)

Pullout opening 5 is a through hole that opens to pull out wire harness 6 therefrom. The expression “pull out wire harness 6” includes: a case where part of the plurality of electric wires 61 included in wire harness 6 are pulled out to the outside of main body portion 3 (the left side in the plane of sheet of FIG. 1; FIG. 2); and a case where other electric wires can be connected to wire harness 6 from the outside of main body portion 3 (the right side in the plane of sheet of FIG. 1; FIG. 3). A specific example of the latter case includes the following case: by fitting, in pullout opening 5, a connector 65 (described below) included in wire harness 6, connector 65 serves as a portion for connection with the other electric wires. One pullout opening 5 may be provided; however, a plurality of pullout openings 5 are normally provided. Pullout opening 5 is formed in main body portion 3, rather than flange portion 4. In this way, no opening is provided in flange portion 4, whereby the mechanical strength (rigidity) of hollow metal tube 2 can be suppressed from being decreased extremely.

A formation location of pullout opening 5 in the axial direction of main body portion 3 is a certain portion of main body portion 3 in the long side direction. The expression “certain portion of main body portion 3 in the long side direction” refers to a portion of main body portion 3 other than the respective ends of main body portion 3, and particularly refers to a region internal to the respective ends of main body portion 3 by 100 mm or more. The formation location of pullout opening 5 in the peripheral direction of main body portion 3 can be appropriately selected in accordance with the protrusion direction of flange portion 4, or the like. When the protrusion directions of flange portions 4 are opposite to each other and cross (are orthogonal to) the vertical direction as in the present example, the formation location of pullout opening 5 in the peripheral direction of main body portion 3 is at the lower side in the vertical direction or, conversely, is at the upper side in the vertical direction. In the case where the formation location of pullout opening 5 in the peripheral direction of main body portion 3 is at the lower side in the vertical direction, even when water drops are generated due to condensation of water vapor inside hollow metal tube 2, the water drops are facilitated to flow to the lower side due to gravity to be thereby discharged from pullout opening 5 to the outside of main body portion 3. Since pullout opening 5 can be thus used as a water discharging hole, water drops are less likely to be accumulated in hollow metal tube 2, whereby the water drops are likely to be suppressed from being adhered to wire harness 6. When a plurality of pullout openings 5 are provided, respective formation locations of pullout openings 5 in the peripheral direction of main body portion 3 may be at the same side or may be at different sides opposite to each other.

For pulling out the plurality of electric wires 61 from pullout opening 5, the size of pullout opening 5 is made larger than the size of connector 65. In this way, connector 65 attached to the tips of the plurality of electric wires 61 can be pulled out from pullout opening 5, whereby the plurality of electric wires 61 can be pulled out from pullout opening 5. For fitting connector 65 therein, the size of pullout opening 5 is made as large as the size of connector 65. In this way, connector 65 does not come off from pullout opening 5. Although depending on the size of connector 65, the length of pullout opening 5 in the axial direction of hollow metal tube 2 is preferably less than or equal to 40% with respect to the entire length of hollow metal tube 2 in the axial direction, for example. When the plurality of pullout openings 5 are provided, the length of pullout opening 5 refers to the total length of the plurality of pullout openings 5. In this way, the strength (rigidity) of hollow metal tube 2 is likely to be suppressed from being decreased extremely. The length of pullout opening 5 is preferably less than or equal to 35% and is more preferably less than or equal to 30% with respect to the entire length of hollow metal tube 2 in the axial direction.

In the present example, pullout opening 5 has two lower side pullout openings 51 that open at the lower side of main body portion 3 in the vertical direction. From one lower side pullout opening 51 (the left side in the plane of sheet of FIG. 1; FIG. 2), pullout part 63 (described below), which is part of the plurality of electric wires 61 in wire harness 6, is pulled out. In the other lower side pullout opening 51 (the right side in the plane of sheet in FIG. 1; FIG. 3), connector 65 in wire harness 6 is fitted. Normally, a space is formed between wire harness 6 and the opening of the lower side pullout opening 51 from which pullout part 63 is pulled out. Therefore, the space can be employed as a water discharging hole.

(Physical Property)

An allowable load E of hollow metal tube 2 for an occupied cross sectional area thereof satisfies ε≥17 N/mm². Allowable load ε is calculated by γ/δ, when α represents a 0.2% proof stress of the material of hollow metal tube 2, β represents a cross sectional area of hollow metal tube 2 except for the internal space thereof, γ represents an axial allowable load of hollow metal tube 2 and is calculated by α×β, and δ represents a total cross sectional area of hollow metal tube 2 and the internal space. Allowable load E herein is a value when it is assumed that no pullout opening 5 is formed in hollow metal tube 2 and first protrusion 41 and second protrusion 42 are joined to each other entirely. It should be noted that even when pullout opening 5 is formed in hollow metal tube 2, allowable load ε is more than or equal to 17 N/mm². For example, in a cross section at pullout opening 5, when the total peripheral length of pullout opening 5 is less than or equal to 40% of the peripheral length of hollow metal tube 2, allowable load ε is more than or equal to 17 N/mm². Since allowable load ε is more than or equal to 17 N/mm², the mechanical strength (rigidity) of hollow metal tube 2 is high. Allowable load ε may be more than or equal to 20 N//mm². Allowable load ε is more preferably more than or equal to 25 N/mm², and is particularly preferably more than or equal to 30 N/mm². It should be noted that allowable load E is less than or equal to 930 N/mm², for example.

(Material)

The material of hollow metal tube 2 is one metal selected from pure Mg, a Mg alloy, pure Al, an Al alloy, pure iron, and an iron alloy. When hollow metal tube 2 is composed of the pure Mg or Mg alloy, hollow metal tube 2 is light in weight and is excellent in flexural rigidity and impact resistance. The pure Al or Al alloy is light in weight, and is excellent in mechanical strength, and also is likely to provide an increased degree of freedom in shape. The pure iron or iron alloy is excellent in flexural rigidity and is very excellent in mechanical strength.

Examples of the Mg alloy include Mg alloys having various compositions with additional elements being contained in Mg (remainder: Mg and inevitable impurity). Particularly, a Mg—Al-based alloy containing at least Al as an additional element is preferable. As the content of Al is larger, corrosion resistance tends to be more excellent and mechanical properties such as strength and plastic deformation resistance tend to be more excellent. Therefore, in the present disclosure, it is more preferable that more than or equal to 3 mass % of Al is contained. It is particularly preferable that more than or equal to 7.3 mass % of Al is contained. It is further preferable that more than or equal to 8 mass % of Al is contained. However, when the content of Al is more than 12 mass %, plastic workability is decreased. Hence, the upper limit thereof is 12 mass %. The content of Al is particularly preferably less than or equal to 11 mass %, and is further preferably more than or equal to 8.3 mass % and less than or equal to 9.5 mass %.

Examples of the additional elements other than Al include one or more elements selected from Zn, Mn, Si, Be, Ca, Sr, Y, Cu, Ag, Sn, Ni, Au, Li, Zr, Ce and a rare earth element (other than Y and Ce). When such element(s) are included, the content(s) thereof are more than or equal to 0.01 mass % and less than or equal to 10 mass %, and are preferably more than or equal to 0.1 mass % and less than or equal to 5 mass % in total. Heat resistance and incombustibility become excellent when more than or equal to 0.001 mass %, preferably, more than or equal to 0.1 mass % and less than or equal to 5 mass % of at least one element selected from Si, Sn, Y, Ce, Ca, and a rare earth element (other than Y and Ce) among the additional elements is contained in total. When the rare earth element(s) are contained, the total content thereof is preferably more than or equal to 0.1 mass %. Particularly, when Y is contained, the content thereof is preferably more than or equal to 0.5 mass %. Examples of the impurity include Fe and the like.

Examples of a more specific composition of the Mg—Al-based alloy include: an AZ-based alloy (Mg—Al—Zn-based alloy; Zn: more than or equal to 0.2 mass % and less than or equal to 1.5 mass %) in the ASTM standard; an AM-based alloy (Mg—Al—Mn-based alloy; Mn: more than or equal to 0.05 mass % and less than or equal to 0.5 mass %); an AS-based alloy (Mg—Al—Si-based alloy; Si: more than or equal to 0.3 mass % and less than or equal to 4.0 mass %); a Mg—Al-RE (rare earth element)-based alloy; an AX-based alloy (Mg—Al—Ca-based alloy; Ca: more than or equal to 0.2 mass % and less than or equal to 6.0 mass %); an AZX-based alloy (Mg—Al—Zn—Ca-based alloy; Zn: more than or equal to 0.2 mass % and less than or equal to 1.5 mass %; Ca: more than or equal to 0.1 mass % and less than or equal to 4.0 mass %); an AJ-based alloy (Mg—Al—Sr-based alloy; Sr: more than or equal to 0.2 mass % and less than or equal to 7.0 mass %); and the like. Specifically, AZ10, AZ31, AZ61, AZ63, AZ80, AZ81, and AZ91, each of which is an AZ-based alloy, are preferable. Particularly, the AZ91 alloy (Mg—Al-based alloy containing more than or equal to 8.3 mass % and less than or equal to 9.5 mass % of Al and more than or equal to 0.5 mass % and less than or equal to 1.5 mass % of Zn) is preferable because the AZ91 alloy has higher specific strength and more excellent corrosion resistance and mechanical property than those of the other AZ-based alloys.

Examples of the Al alloy include an A5052 alloy (5000-series alloy) and the like.

Examples of the iron alloy include steel and the like. Examples of a specific steel include: a rolled steel for general structure (JIS G 3101: 2010); a high-tensile steel; and the like.

When hollow metal tube 2 is formed by combining two (plural) divided pieces P1, P2 as in the present example, two (all) divided pieces P1, P2 may be composed of the same material, or one (at least one) divided piece P1 and the other divided piece P2 (the other divided pieces P2) may be composed of different materials. For example, one divided piece P1 can be composed of a Mg alloy, and the other divided piece P2 can be composed of an Al alloy.

Each of two (all) divided pieces P1, P2 may be constituted of a plate member, or one (at least one) divided piece P1 may be constituted of a plate member and the other (one) divided piece P2 may be constituted of a block member. For the plate member, it is possible to use: a die cast member having a predetermined shape; or a pressed member obtained by press-molding a flat plate-like cast member or a rolled member into a predetermined shape. Examples of the block member include: a die cast member; an extruded member; a forged member; and the like.

[Wire Harness]

Wire harness 6 has the plurality of electric wires 61 and connectors 65. For each electric wire, a coated electric wire including an electric conductor and an electric insulator can be used, for example. Each of connectors 65 is connectable to a connector or the like of an intended wire harness. Connectors 65 are provided at respective end portions of the plurality of electric wires 61. A well-known wire harness can be used for wire harness 6.

The plurality of electric wires 61 in the present example include: stored part 62, which is part of electric wires 61 in the long side direction and is stored inside main body portion 3; and pullout part 63, which is the other part thereof in the long side direction and is pulled out of main body portion 3 via lower side pullout opening 51. Connectors 65 are provided at the respective tips of stored part 62 and pullout part 63. Connector 65 at the tip of stored part 62 is fitted in the other lower side pullout opening 51, whereas connector 65 at the tip of pullout part 63 is pulled out of main body portion 3 via one lower side pullout opening 51. Connector 65 at the tip of stored part 62 includes an engagement mechanism that is mechanically engageable with an peripheral edge portion of pullout opening 5 so as to avoid connector 65 from coming off from pullout opening 5 when fitted in pullout opening 5. Examples of this engagement mechanism include a snap fitting and the like. Since movement of wire harness 6 in hollow metal tube 2 can be likely to be suppressed by connector 65 fitted in lower side pullout opening 51, wire harness 6 and hollow metal tube 2 can be readily handled as one piece. Pullout part 63 pulled out from lower side pullout opening 51 is not regulated in its movement outside main body portion 3, and is handled freely to some extent. Accordingly, pullout part 63 can be readily directed in various directions, and connector 65 at the tip of pullout part 63 can be readily connected to a connector of an intended wire harness.

[Others]

When a method involving generation of heat of more than or equal to a predetermined temperature is used as the fixation method for first protrusion 41 and second protrusion 42, beam member 1A preferably include a heat insulator 7 (FIG. 1 to FIG. 3) that protects wire harness 6 from the heat. Examples of such a fixation method include friction stir welding, laser welding, and the like. By including heat insulator 7, the electric insulator of each electric wire can be suppressed from being damaged by the heat. A type of heat insulator 7 is not particularly limited and can be selected appropriately as long as heat insulator 7 can withstand the above-described heat. Examples of heat insulator 7 include rock wool and glass wool. Heat insulator 7 is interposed between wire harness 6 and hollow metal tube 2. Heat insulator 7 is disposed at least at the flange portion 4 (friction-stir-welded portion 43) side in wire harness 6. Heat insulator 7 in the present example is provided to surround the entire outer periphery of stored part 62. It should be noted that heat insulator 7 may be disposed on the inner peripheral surface of main body portion 3. This heat insulator 7 can be used also as a bundling member that bundles the plurality of electric wires 61. Heat insulator 7 may be constituted of a tubular member in which the plurality of electric wires 61 can be stored, or may be formed by winding a tape material.

[Manufacturing Method]

Beam member 1A can be manufactured by a beam member manufacturing method including a preparing step and a fixing step.

In the preparing step, first divided piece P1, second divided piece P2 provided with pullout opening 5, and wire harness 6 are prepared. Each of first divided piece P1 and second divided piece P2 can be produced by a forming step of press-forming, into a predetermined shape, a punched plate member (for example, an elongated strip-like member) obtained by punching a flat plate into a predetermined shape, for example. Pullout opening 5 of second divided piece P2 can be formed by punching during the above-described punching for producing the plate member. It should be noted that each of divided pieces P1, P2 may be produced through die casting.

In the fixing step, wire harness 6 is stored inside first divided piece P1 and second divided piece P2, and protrusions 41, 42 are disposed to face each other and are fixed to each other. Before fixing protrusions 41, 42 to each other, connector 65 may be fitted in pullout opening 5 or may be pulled out from pullout opening 5 in advance. Since the location of pullout opening 5 is determined, the fitting of connector 65 into pullout opening 5 and the pullout of connector 65 from pullout opening 5 can be automated. First protrusion 41 and second protrusion 42 are stacked on each other such that respective side surfaces of first protrusion 41 and second protrusion 42 are aligned with each other. Then, a friction stir welding tool (not shown) having a shoulder and a probe is rotated and is moved in the long side direction of first protrusion 41 while pressing the surface of first protrusion 41, thus attaining friction stir welding of protrusions 41, 42.

[Application]

Beam member 1A according to the first embodiment can be used suitably for a beam member that requires rigidity for vehicles. Particularly, beam member 1A can be used suitably for a steering support member (reinforcement) that supports a steering wheel. This steering support member is bridged between A pillars (dash side panels) at an internal side (engine compartment side) relative to an instrument panel (dash board panel) of a vehicle.

[Function and Effect]

Beam member 1A according to the first embodiment can attain space saving. This is due to the following reason: since hollow metal tube 2 that stores wire harness 6 therein is included, wire harness 6 does not need to be attached to the outer peripheral surface of hollow metal tube 2. Moreover, since wire harness 6 and hollow metal tube 2 can be handled as one piece, the number of components can be reduced. Moreover, since wire harness 6 is stored in hollow metal tube 2, wire harness 6 can be mechanically protected from an external environment, whereby damage to wire harness 6 is likely to be suppressed. Further, pullout opening 5 is provided at a certain portion of hollow metal tube 2. Hence, by appropriately adjusting the location of pullout opening 5, wire harness 6 can be pulled out from any location, thus resulting in a high degree of freedom in routing wire harness 6. Since hollow metal tube 2 includes flange portions 4 and has an allowable load ε of more than or equal to 17 N/mm², the mechanical strength (rigidity) can be improved, whereby the mechanical strength (rigidity) can be suppressed from being decreased even though pullout opening 5 is formed in main body portion 3. When the peripheral length of main body portion 3 is the same as the peripheral length of a main body portion 3 of a below-described beam member 1B according to the second embodiment, the cross sectional area of the internal space in main body portion 3 can be made small, thereby facilitating space saving.

### Second Embodiment

[Beam Member]

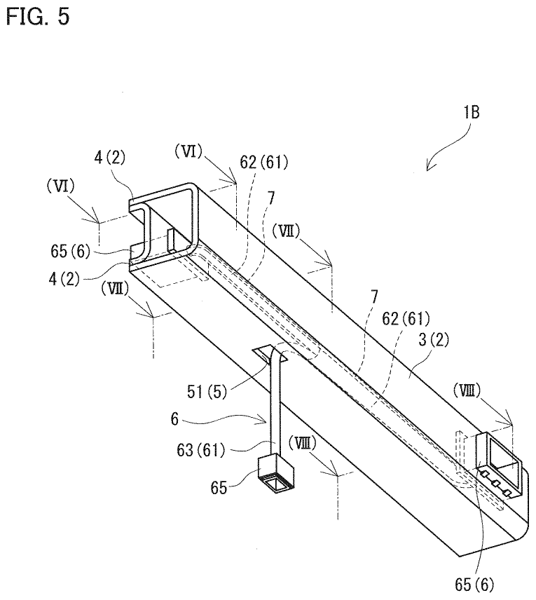

With reference to FIG. 5 to FIG. 8, beam member 1B according to the second embodiment will be described. Beam member 1B is mainly different from beam member 1A of the first embodiment in the following points: the cross sectional shape of main body portion 3 (the cross sectional shape of the internal space) is a rectangular loop shape (rectangular shape); and two flange portions 4 do not exist on the same plane and protrude in the same direction. Although beam member 1B is the same as beam member 1A of the first embodiment in that two flange portions 4 protrude in a direction orthogonal to the vertical direction, two flange portions 4 may protrude toward the lower or upper side in the vertical direction. In the description below, the differences from the first embodiment will be mainly described, and the same configuration will not be described.

[Hollow Metal Tube]

(Main Body Portion and Flange Portion)

First divided piece P1 and second divided piece P2 have similar shapes, and each of first divided piece P1 and second divided piece P2 is constituted of a gutter-like plate member with three surrounding flat surfaces. The size of the cross sectional shape of first divided piece P1 is larger than the size of the cross sectional shape of second divided piece P2.

First divided piece P1 includes: a gutter-like peripheral wall portion 31 with three surrounding flat surfaces; and a pair of first protrusions 41 straightly extending from respective ends of peripheral wall portion 31. Peripheral wall portion 31 has two bent portions. Peripheral wall portion 31 has: two parallel flat surfaces; and a flat surface that are orthogonal to the two flat surfaces and that connects between ends of the two parallel flat surfaces. The pair of first protrusions 41 are parallel to each other. Second divided piece P2 includes: a peripheral wall portion 32; and a pair of second protrusions 42 that externally protrude from respective ends of peripheral wall portion 32 in the radial direction so as to cross (in the present example, so as to be orthogonal to) peripheral wall portion 32. The pair of second protrusions 42 are parallel to each other, and are parallel to the pair of first protrusions 41. Since protrusions 41, 42 are in the form of flat plates and are disposed in parallel with each other, protrusions 41, 42 can be in surface contact with each other. It should be noted that two flange portions 4 may not be parallel to each other.

First divided piece P1 and second divided piece P2 are combined such that respective openings of first divided piece P1 and second divided piece P2 are directed at the same side and the pair of second protrusions 42 are disposed inside the pair of first protrusions 41. Namely, three sides of the four sides of the rectangular cross section of main body portion 3 are constituted of peripheral wall portion 31 of first divided piece P1, and the remaining one side is constituted of peripheral wall portion 32 of second divided piece P2. First protrusion 41 and second protrusion 42 at one side are disposed to face each other, and first protrusion 41 and second protrusion 42 at the other side are disposed to face each other.

When a protrusion side pullout opening 52 (described below) is provided between two flange portions 4 as in the present example and connector 65 is fitted in protrusion side pullout opening 52, a spacing between two flange portions 4 preferably has a size to avoid interference with connector 65. Moreover, when the fixation method for first protrusion 41 and second protrusion 42 is friction stir welding, each of the spacing between two flange portions 4 and the width of each flange portion 4 preferably has such a size that a friction stir welding tool or a supporting member facing the tool with flange portion 4 being interposed therebetween can be disposed on one flange portion 4 without an interference with the other flange portion 4. Since both flange portions 4 protrude in the same direction of beam member 1B, an operation for joining flange portions 4 can be performed in the same direction. In the present example, the side surfaces of first divided piece P1 and second divided piece P2 are aligned with each other, but may be deviated from each other in the width direction of flange portion 4.

It should be noted that examples of the cross sectional shape of main body portion 3 (the cross sectional shape of the internal space) can include: other polygonal loop shapes (polygonal shapes) such as a rectangular loop shape (rectangular shape); a semicircular loop shape (semicircle shape); a bow-like loop shape (bow-like shape) in the form of a bow with a bowstring and an arc; and the like. Examples of the polygonal loop shape (polygonal shape) include a triangular loop shape (triangular shape), a pentagonal loop shape (pentagonal shape), a hexagon loop shape (hexagonal shape), an octagonal loop shape (octagonal shape), and the like.

(Pullout Opening)

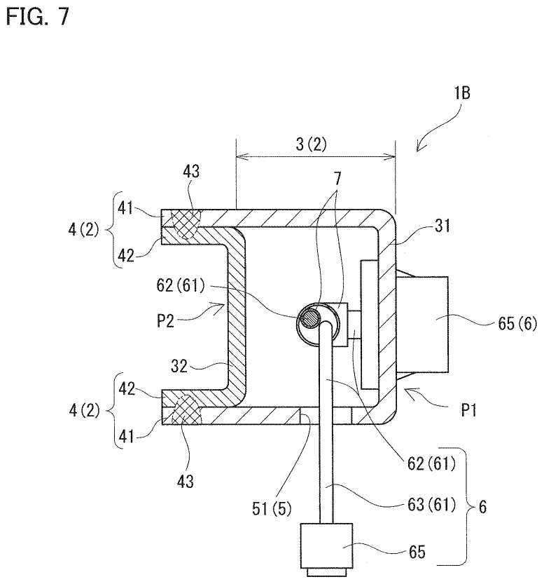

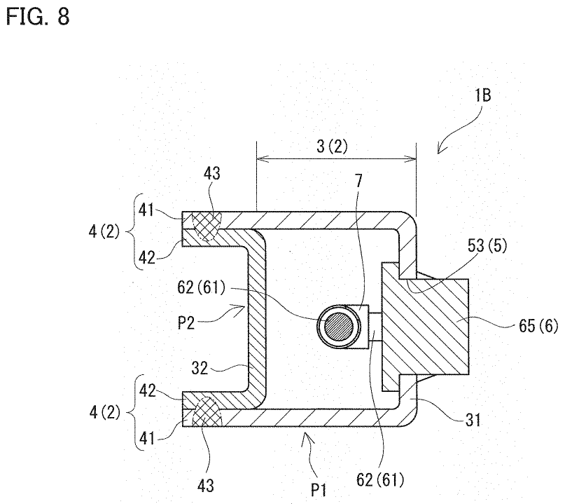

When flange portions 4 protrude in the same direction that crosses (is orthogonal to) the vertical direction as in the present example, the formation location of pullout opening 5 in the peripheral direction of main body portion 3 is at the lower side in the vertical direction, is at the upper side in the vertical direction, is in the protrusion direction of flange portions 4, or is in a direction opposite to the protrusion direction of flange portions 4. Pullout opening 5 in the present example has lower side pullout opening 51 (FIG. 5, FIG. 7), protrusion side pullout opening 52 (FIG. 6), and an opposite side pullout opening 53 (FIG. 8). The number of each of these pullout openings 51 to 53 is one but may be plural. Protrusion side pullout opening 52 is disposed in the same direction as the protrusion direction of flange portions 4 in main body portion 3, and opens between two flange portions 4. Opposite side pullout opening 53 opens in a direction opposite to the protrusion direction of flange portions 4 in main body portion 3. That is, opposite side pullout opening 53 and projection side pullout opening 52 open in opposite directions.

From lower side pullout opening 51 in the present example, pullout part 63 of wire harness 6 is pulled out, whereas connector 65 of wire harness 6 is fitted in each of protrusion side pullout opening 52 and opposite side pullout opening 53. Since connector 65 fitted in protrusion side pullout opening 52 has a portion that is exposed through the protrusion side pullout opening 52 and that is surrounded by two flange portions 4, connector 65 can be readily protected mechanically. Accordingly, damage to connector 65 is likely to be suppressed.

It should be noted that although two flange portions 4 protrude in the direction orthogonal to the vertical direction, two flange portions 4 may protrude toward the lower or upper side in the vertical direction. For example, when two flange portions 4 protrude toward the lower side in the vertical direction, protrusion side pullout opening 52 is also lower side pullout opening 51.

[Wire Harness]

The plurality of electric wires 61 in wire harness 6 are bifurcated at a certain part in the long side direction. The plurality of electric wires 61 have a part at the root side of the bifurcation (at the side opposite to the bifurcation) and one bifurcated part. These parts serve as stored part 62 stored in main body portion 3. The plurality of electric wires 61 have the other bifurcated part, which serves as pullout part 63 that is pulled out of main body portion 3 via lower side pullout opening 51. Connectors 65 are provided at three locations in total, i.e., are provided at the respective ends of stored part 62 and the tip of pullout part 63. Connector 65 at one end side (tip of the bifurcation) in stored part 62 is fitted in protrusion side pullout opening 52, whereas connector 65 at the other end side (opposite tip of the bifurcation) in stored part 62 is fitted in opposite side pullout opening 53. These connectors 65 are engaged with respective peripheral edge portions of pullout openings 52, 53 by engagement mechanisms such as snap fittings so as not to come off from pullout openings 5. Connector 65 at the tip of pullout part 63 is pulled out of main body portion 3 via lower side pullout opening 51. Heat insulator 7 is provided on substantially the entire outer periphery of stored part 62.

[Function and Effect]

Beam member 1B according to the second embodiment exhibits the same effect as that of beam member 1A according to the first embodiment. Moreover, when the cross sectional area of the internal space of main body portion 3 is made the same as the cross sectional area of the internal space of main body portion 3 of beam member 1A according to the first embodiment, the peripheral length of main body portion 3 can be shortened, thereby facilitating weight saving.

### Test Example 1

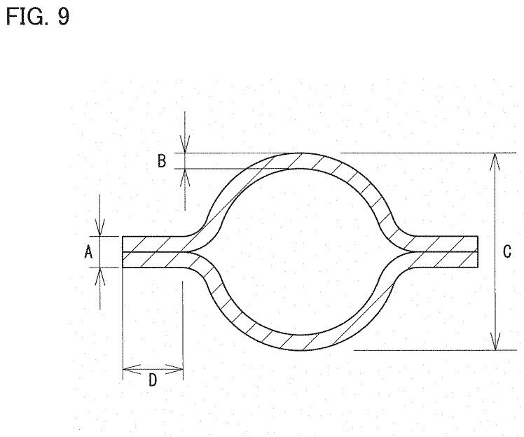

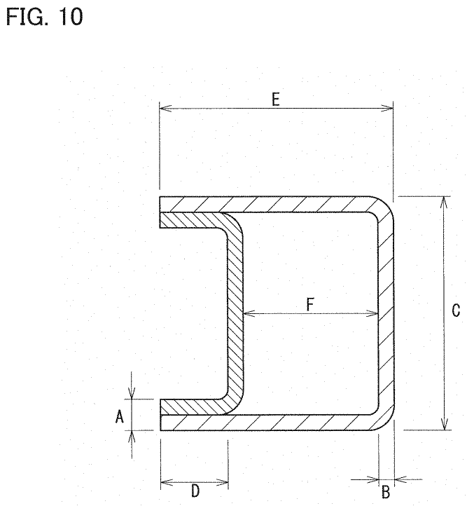

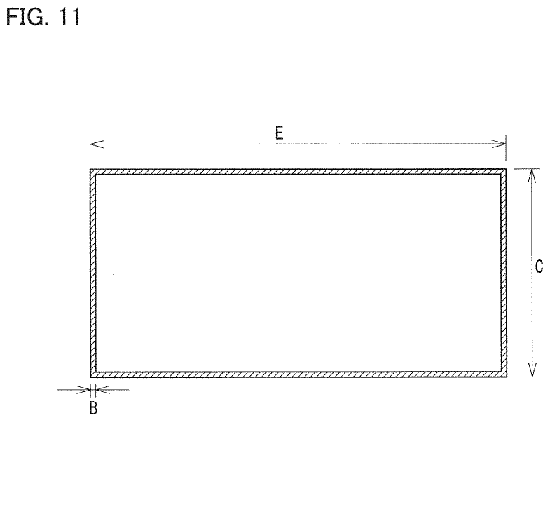

Respective mechanical strengths (rigidities) of hollow metal tubes of samples No. 1 to No. 4 each shown in FIG. 9, a hollow metal tube of a sample No. 5 shown in FIG. 10, and hollow metal tubes of samples No. 101, No. 102 shown in FIG. 11 were evaluated through simulation. The simulation was performed using commercially available simulation software (SOLIDWORKS provided by SOLIDWORKS Japan).

[Samples No. 1 to No. 4]

Each of the hollow metal tubes of samples No. 1 to No. 4 each shown in FIG. 9 is the same as hollow metal tube 2 of beam member 1A according to the first embodiment described with reference to FIG. 1 to FIG. 4, except that no pullout opening is formed. That is, the first divided piece and the second divided piece have the same shape and the same size. Each of the first divided piece and the second divided piece includes: a peripheral wall portion having a cross section with a semicircular arc shape; and a pair of protrusions. The first protrusion and the second protrusion at each of one side and the other side are disposed to face each other such that the side surfaces thereof are aligned with each other. It is assumed that the first protrusion and the second protrusion at each of one side and the other side are joined to each other across the entire region at which they face each other. The material of each divided piece and dimensions A to D shown in FIG. 9 were as shown in Table 1. A steel of sample No. 4 is a high-tensile steel (440-MPa class). Dimension A represents the thickness of the flange portions, dimension B represents the thickness (=A/2) of each divided piece, dimension C represents the height of the hollow metal tube (the height (outer diameter) of the main body portion), and dimension D represents the width of each flange portion.

[Sample No. 5]

The hollow metal tube of sample No. 5 shown in FIG. 10 is the same as hollow metal tube 2 of beam member 1B according to the second embodiment described with reference to FIG. 5 to FIG. 8, except that no pullout opening is formed. That is, the first divided piece and the second divided piece have similar shapes, have different sizes, and are constituted of gutter-like plate members each with three surrounding flat surfaces. Specifically, the size of the cross sectional shape of the first divided piece is larger than the size of the cross sectional shape of the second divided piece. The first divided piece includes: a gutter-like peripheral wall portion with three surrounding flat surfaces; and a pair of first protrusions extending straightly from respective ends of the peripheral wall portion so as to be parallel to each other. The second divided piece includes: a straight peripheral wall portion; and a pair of second protrusions externally protruding from respective ends of the peripheral wall portion in the radial direction so as to be orthogonal to the peripheral wall portion. The pair of first protrusions and the pair of second protrusions are parallel to each other. The first protrusion and the second protrusion at each of one side and the other side are disposed to face each other such that the side surfaces thereof are aligned with each other. It is assumed that the first protrusion and the second protrusion at each of one side and the other side are joined to each other across the entire region at which they face each other. The material of each divided piece and dimensions A to F shown in FIG. 10 were as shown in Table 1. Dimension A represents the thickness of the flange portions, dimension B represents the thickness (=A/2) of each divided piece, dimension C represents the height of the hollow metal tube (the height of the main body portion), dimension D represents the width of each flange portion, dimension E represents the width of the hollow metal tube (total width of the main body portion and the flange portion), and dimension F is the internal dimension (E−B×2−D) of the main body portion in the width direction.

[Samples No. 101, No. 102]

Each of the hollow metal tubes of samples No. 101 and No. 102 in FIG. 11 is a rectangular tube having no juncture in the peripheral direction. The material of this hollow metal tube and dimensions B, C, and E shown in FIG. 11 were as shown in Table 1. A steel of each of samples No. 101 and No. 102 is the same as the steel of sample No. 4. Dimension B represents the thickness of the hollow metal tube, dimension C represents the height of the hollow metal tube, and dimension E represents the width of the hollow metal tube.

[Evaluations on Strengths]

An evaluation on the strength of each sample was performed by calculating an allowable load ε of the hollow metal tube for an occupied cross sectional area of the hollow metal tube. Allowable load ε is calculated by γ/δ, when α represents a 0.2% proof stress of the material of the hollow metal tube, β represents a cross sectional area of the hollow metal tube except for the internal space thereof, γ represents an axial allowable load of the hollow metal tube and is calculated by α×β, and δ represents a total cross sectional area of the hollow metal tube and the internal space. Allowable load E is a value when it is assumed that no pullout opening is formed in the hollow metal tube and the first protrusion and the second protrusion are joined to each other entirely. Results thereof are shown in Table 1.

TABLE 1

| | Material | | | | | | | | | | | | |
|---|---|---|---|---|---|---|---|---|---|---|---|---|---|
| | First | Second | | Dimension | | | | | | | | | |
| Sample | Divided | Divided | α | A | B | C | D | E | F | δ | β | γ | ε |
| No. | Piece | Piece | (MPa) | (mm) | (mm) | (mm) | (mm) | (mm) | (mm) | (mm²) | (mm²) | (N) | (N/mm²) |
| 1 | AZ91 | AZ91 | 280 | 6 | 3 | 70 | 20 | — | — | 4093 | 852 | 238560 | 58 |
| 2 | AZ91 | AZ91 | 280 | 26 | 3 | 38 | 20 | — | — | 1377 | 553 | 154840 | 112 |
| 3 | AZ91 | AZ91 | 280 | 5 | 2.5 | 38 | 20 | — | — | 1333 | 458 | 128240 | 96 |
| 4 | Steel | Steel | 243 | 2 | 1 | 38 | 20 | — | — | 1217 | 189 | 45927 | 38 |
| 5 | AZ91 | AZ91 | 280 | 6 | 3 | 45 | 18 | 58 | 34 | 2008 | 675 | 189000 | 94 |
| 101 | Steel | Steel | 243 | — | 0.5 | 100 | — | 200 | — | 20000 | 301 | 73143 | 4 |
| 102 | Steel | Steel | 243 | — | 1 | 100 | — | 700 | — | 70000 | 1604 | 389772 | 6 |

As shown in Table 1, it was found that allowable load E of the hollow metal tube of each of samples No. 1 to No. 5 for the occupied cross sectional area of the hollow metal tube was more than or equal to 17 N/mm². On the other hand, it was found that allowable load ε of the hollow metal tube of each of samples No. 101, No. 102 for the occupied cross sectional area of the hollow metal tube was less than 10 N/mm². That is, it was found that the hollow metal tube of each of samples No. 1 to No. 5 had a much higher strength (high rigidity) than that of the hollow metal tube of each of samples No. 101, No. 102.

Particularly, it was found that the hollow metal tubes of samples No. 1 to No. 3 and No. 5, each of which included the first divided piece and the second divided piece each composed of AZ91, had an allowable load ε of more than or equal to 30 N/mm², an allowable load ε of more than or equal to 50 N/mm², an allowable load E of more than or equal to 90 N/mm², and an allowable load E of more than or equal to 100 N/mm², and therefore had particularly high strengths (high rigidities). The hollow metal tube of sample No. 4, which included the first divided piece and the second divided piece each composed of a steel, had an allowable load ε of more than or equal to 30 N/mm², and therefore had a very high strength (high rigidity).

### Test Example 2

Respective strengths (rigidities) of hollow metal tubes of samples No. 11, No. 12, which were obtained by forming pullout openings in the main body portions of the hollow metal tubes of samples No. 1, No. 4 in test example 1, were evaluated through simulation in the same manner as in test example 1. Each of the pullout openings of the hollow metal tubes of samples No. 11, No. 12 was formed such that the peripheral length of the pullout opening became 40% of the peripheral length of the hollow metal tube in a cross section at the pullout opening.

The evaluation on the strength of each sample was performed by calculating an allowable load ε′ of the hollow metal tube for an occupied cross sectional area of the hollow metal tube. As with allowable load E of the hollow metal tube of each of samples No. 1, No. 4, allowable load ε′ of the hollow metal tube of each of samples No. 11, No. 12 is calculated by γ/δ′, i.e., α′×β/δ′. 0.2% proof stress α′ in the material of the hollow metal tube of each of samples No. 11, No. 12 is the same as 0.2% proof stress α in the material of the hollow metal tube of each of samples No. 1, No. 4. Cross sectional area β′ of the hollow metal tube of each of samples No. 11, No. 12 is a value obtained by excluding the cross sectional area of the pullout opening from cross sectional area β of each of samples No. 1, No. 4. As with each of samples No. 1, No. 4, axial direction allowable load γ′ of the hollow metal tube of each of samples No. 11, No. 12 is calculated by α′×β′. Total cross-sectional-area δ′ of the hollow metal tube, internal space, and pullout opening of each of samples No. 11, No. 12 is the same as total cross sectional area δ of the hollow metal tube of each of samples No. 1, No. 4.

Allowable load ε′ of the hollow metal tube of sample No. 11 for the occupied cross sectional area of the hollow metal tube was 35 N/mm², and allowable load ε ′ of the hollow metal tube of sample No. 12 for the occupied cross sectional area of the hollow metal tube was 23 N/mm². Thus, it was found that the hollow metal tube of each of samples No. 11, No. 12 had a much higher strength (high rigidity) than that of the hollow metal tube of each of samples No. 101, No. 102.

In view of test examples 1, 2, since the hollow metal tube of each of samples No. 1 to No. 5, No. 11 and No. 12 is excellent in strength (rigidity), it is considered that the hollow metal tube can be used suitably for a beam member that requires rigidity for vehicles, particularly, a steering support member. Moreover, by storing the wire harness in the hollow metal tube, the hollow metal tube excellent in the strength (rigidity) is less likely to be damaged even when external force acts on the hollow metal tube, with the result that it is considered that the wire harness therein is likely to be suppressed from being damaged due to damage of the hollow metal tube.

The present invention is defined by the terms of the claims, rather than these examples, and is intended to include any modifications within the scope and meaning equivalent to the terms of the claims.

### REFERENCE SIGNS LIST

1A, 1B: beam member; 2: hollow metal tube; 3: main body portion; 31, 32: peripheral wall portion; 4: flange portion; 41: first protrusion; 42: second protrusion; 43: friction-stir-welded portion; 44: through hole; 5: pullout opening; 51: lower side pullout opening; 52: protrusion side pullout opening; 53: opposite side pullout opening; 6: wire harness; 61: plurality of electric wires; 62: stored part; 63: pullout part; 65: connector; 7: heat insulator; 8: fastening member; 81: bolt; 82: nut; P1: first divided piece; P2: second divided piece

1: A beam member comprising:
a wire harness; and
a hollow metal tube provided to cover at least a portion of the wire harness, wherein
the hollow metal tube is provided with
a main body portion that covers at least the portion of the wire harness,
at least one first protrusion,
at least one second protrusion,
at least one flange portion at which a pair of the first protrusion and the second protrusion are fixed, the at least one flange portion protruding toward an outside of the main body portion along a long side direction of the hollow metal tube, and
an opening serving as a pullout opening for the wire harness and located at a certain portion of the main body portion in the long side direction, and
ε≥17 N/mm² is satisfied when α represents a 0.2% proof stress of a material of the hollow metal tube, β represents a cross sectional area of the hollow metal tube except for an internal space of the hollow metal tube, γ represents an axial allowable load of the hollow metal tube and is calculated by α×β, δ represents a total cross sectional area of the hollow metal tube and the internal space, and ε represents an allowable load of the hollow metal tube for an occupied cross sectional area of the hollow metal tube and is calculated by γ/δ.

2: The beam member according to claim 1, wherein the wire harness has at least one of a connector fitted in the pullout opening and a pullout part pulled out from the pullout opening toward the outside of the main body portion.

3: The beam member according to claim 1, wherein the pullout opening has a lower side pullout opening that opens at a lower side of the main body portion in a vertical direction.

4: The beam member according to claim 1, wherein
the hollow metal tube is formed by combining a first divided piece and a second divided piece, and has one main body portion and two flange portions protruding in opposite directions,
the first divided piece has
a first peripheral wall portion that forms a portion of the main body portion, and
two first protrusions that protrude, in the opposite directions, from respective ends of the first peripheral wall portion to form respective portions of the flange portions, and
the second divided piece has
a second peripheral wall portion that forms a portion of the main body portion, and
two second protrusions that protrude, in the opposite directions, from respective ends of the second peripheral wall portion to form respective portions of the flange portions.

5: The beam member according to claim 1, wherein
the hollow metal tube is formed by combining a first divided piece and a second divided piece, and has one main body portion and two flange portions protruding in the same direction,
the first divided piece has
a first peripheral wall portion that forms a portion of the main body portion, and
two first protrusions that protrude, in the same direction, from respective ends of the first peripheral wall portion to form respective portions of the flange portions, and
the second divided piece has
a second peripheral wall portion that forms a portion of the main body portion, and
two second protrusions that protrude, in the same direction, from respective ends of the second peripheral wall portion to form respective portions of the flange portions.

6: The beam member according to claim 5, wherein
the pullout opening has a protrusion side pullout opening that opens between the two flange portions in the same direction as the protrusion direction of the flange portions in the main body portion, and
the wire harness has a connector fitted in the protrusion side pullout opening.

7: The beam member according to claim 1, wherein the material of the hollow metal tube is one metal selected from pure magnesium, a magnesium alloy, pure aluminum, an aluminum alloy, pure iron, and an iron alloy.

8: The beam member according to claim 1, wherein the flange portion has a friction-stir-welded portion at which the first and second protrusions disposed to face each other are friction-stir-welded.

9: The beam member according to claim 8, further comprising a heat insulator interposed between the wire harness and the hollow metal tube to protect the wire harness from heat resulting from the friction stir welding.

10: The beam member according to claim 1, further comprising a fastening member that fastens the first and second protrusions disposed to face each other, in a stacking direction of the first and second protrusions, wherein
each of the first and second protrusions is provided with a through hole in which the fastening member is insertable.
